(19) United States
(12) Patent Application Publication
(10) Pub. No.: US 2006/0280109 A1
(43) Pub. Date: Dec. 14, 2006

(54) Optical information recording medium, optical information recording method, optical information record/reproduce apparatus and semiconductor circuit

(76) Inventors: Kenji Narumi, Osaka (JP); Kenji Koishi, Hyogo (JP); Kouhei Akimoto, Fukuoka (JP); Kenichi Nishiuchi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/450,294

(22) Filed: Jun. 12, 2006

(30) Foreign Application Priority Data
Jun. 14, 2005 (JP) 2005-173307
Dec. 20, 2005 (JP) 2005-366910

(51) Int. Cl. G11B 7/24; G11B 7/00; G11B 7/125

(52) U.S. Cl. 369/275.3; 369/44.33; 369/53.27

(57) ABSTRACT

The object of the present invention is to make an appropriate determination of whether recording is prohibited or not depending on the type of record/reproduce apparatus. To achieve the object, optical disk 1 of the present invention that can record or reproduce information through irradiation with laser light comprises a recording area 6 for recording the information, and a management area for recording management information of the optical disk 1, wherein the management area includes a recordable write-inhibit flag area 7 with a record/reproduce apparatus, and at least two types of the identifying information that are independent one another and identify whether recording is prohibited or not respectively for at least two recording linear velocities are recorded in the write-inhibit flag area 7.

### BACKGROUND OF THE INVENTION

1. Field of the Invention

The present invention relates to an optical information recording medium for optically recording and reproducing data, a recording method and a record/reproduce apparatus, and in particular relates to a recording medium format.

2. Description of the Prior Art

In recent years, recording media for optically recording data that have been proposed or developed include optical disks, optical cards, optical tapes and the like. Among these, the optical disk has received attention as a medium with high capacity and the ability to record and reproduce data at high density.

The phase-change optical disk is one design for a rewritable type optical disk. Depending on the laser light heating conditions and cooling conditions, the recording film used in the phase-change optical disk can be either in the amorphous state or the crystalline state. Moreover, there is reversibility in the amorphous state and the crystalline state. In the abovementioned amorphous state and crystalline state, the optical constants in the recording film (refractive index and extinction coefficient) are different. In the phase-change optical disk, the recording layer can be formed selectively in two states depending on the information signal, with the result that the optical change produced (changes in transmittance or reflectance) can be utilized in recording or reproducing the information signal.

In order to obtain the abovementioned two states, the information signal is recorded according to the methods given below. Laser light focused by the optical head is irradiated in pulses (referred to as recording pulses) onto the recording film of the optical disk, the temperature of the recording layer is elevated above the melting point, so that with the laser light passing through together with rapid cooling, the melted portion makes an amorphous state mark. In addition, when irradiated with a focused, strong laser light that elevates the temperature of the recording film to a level above the crystallization temperature and below the melting temperature, the irradiated portion of the recording layer adopts the crystalline state. Furthermore, this power level is referred to as the erasing power.

In order to increase the transfer rate for optical disks, there is a demand for the recording capability at high recording linear velocities (linear velocity) to be improved. For this reason, optical disks that can record at faster speed are being developed and commercialized. As one example, in contrast to the recording linear velocity of 8.2 m/s for the earlier disks, a DVD-RAM rewritable type optical disk (recording capacity 4.7 GB) can record at 12.4 m/s or 20.5 m/s, and disks that can record at comparatively higher linear velocities are being commercialized.

These high recording-speed disks are designed so that they can also be used to record on a conventional record/reproduce apparatus at low linear velocities. Specifically, disks capable of recording at 12.4 m/s or 20.5 m/s will also be able to record at 8.2 m/s with good signal quality.

Moreover, a version/revision identifier is generally recorded in the management area of the disk so that the record/reproduce apparatus can determine the disk version or revision, and on that basis decide the linear velocity. The management area is an area where individual information about the disk is recorded, and the record/reproduce apparatus refers to this area prior to recording any actual information.

The basic format of a DVD-RAM is described further in ECMA International Standard, ECMA-330, 2nd Edition.

In the case of a cartridge-type optical disk, there is a hole in a designated area of the cartridge that will be either open or plugged up that determines whether recording on the corresponding optical disk is permitted (recordable) or prohibited (non-recordable). The record/reproduce apparatus detects the status of this designated area of the cartridge with a sensor and in this way controls whether or not the recording operation is carried out on the optical disk.

In the case of the type of optical disk without a cartridge, there is a designated area on the disk where an identifier (flag) that identifies whether recording is prohibited or not is recorded as identifying information. This area where the identifying information is recorded is referred to as the write-inhibit flag area. Many of these write-inhibit flag areas are provided within the disk identification area within the management area, and can be recorded by the record/reproduce apparatus. Additionally, a physical format information area (lead-in area) is provided within the management area. This area is only recordable by the disk manufacturer. The disk identification area and the physical format information area are described further in ECMA International Standard, ECMA-330, 2nd Edition.

After the optical disk is introduced (in other words, loaded), the record/reproduce apparatus reproduces the identifying information in the write-inhibit flag area before recording any information. Based on this identifying information, the record/reproduce apparatus decides whether or not to carry out the recording operation

In this way, the user can avoid recording over important content by mistake. In addition, the manufacturer can also prohibit the user from arbitrarily recording on a disk that is not intended for recording.

However, even with the advanced optical disks that have been developed in recent years, it is difficult to obtain completely uniform recording performance over a broad range of linear velocities. This is due to the reasons given below.

In phase-change optical disks, in order to be able to erase a mark at high linear velocity, a readily crystallizable recording film material is generally used. This is because that, at a high linear velocity, the transit time during which a laser spot is seen on a point on the optical disk is shorter, and a mark in the amorphous state will not be able to reach the crystalline state unless the material is readily crystallizable.

At the same time, in contrast to optical disks that employ such recording film materials, even if the mark is recorded at extremely low linear velocities, it will not be possible to form a mark of adequate size. This is because that, since the laser spot passes through slowly, the cooling speed becomes slower because of the cumulative effect of the heat of the recording layer, and essentially the portion that is desirable to form a mark in the amorphous state will still be partially crystalline.

Consequently, in recordable optical disks with higher linear velocities, it will not be possible to achieve recordings of sufficiently good quality at the conventional low linear velocities. Such a case is produced, for example, in optical disks that are able to record at a linear velocity of 65.6 m/s, where the signal quality decreases when recording at 8.2 m/s. In such optical disks, it is desirable to prohibit recording at a linear velocity of 8.2 m/s.

However, when loading optical disks that are actually able to record at 65.6 m/s into a conventional record/reproduce apparatus (that is, corresponding to recording linear velocity of 8.2 m/s), the record/reproduce apparatus does not properly recognize the optical disk with the result that there will be recording by mistake. One of the reasons for this is that in conventional optical disks, the identifying information that identifies whether the optical disk is recordable or non-recordable is configured to be independent of the linear velocity. An additional reason is that possibly at the point in time when the conventional record/reproduce apparatus was commercialized, there were no optical disks capable of recording at 65.6 m/s, so that the version/revision identifier for an optical disk capable of recording at 65.6 m/s cannot be recognized by this record/reproduce apparatus.

A concrete explanation is provided here for the procedure in a record/reproduce apparatus that decides the linear velocity, using FIG. 14 and Table 1. FIG. 14 is a flowchart that explains the procedure for a record/reproduce apparatus that is capable of recording at linear velocities of from 8.2 m/s to 20.5 m/s.

The optical disk is loaded into the record/reproduce apparatus, and the optical disk is rotated at the designated linear velocity (for example, at 8.2 m/s) (step 601, referred to below as S601).

Next, the optical disk is irradiated with laser light, and a focusing or tracking operation is carried out. Then the optical head seeks the management area of the optical disk, and begins a reproduce of the management area (S602).

The record/reproduce apparatus reproduces the version/revision identifier within the management area, and the version/revision number is read out (S603). The record/reproduce apparatus includes a table inside that is for determining the recording linear velocity corresponding to the disk from the version/revision (Table 1 shows an example of such the table). By referring to this table, the record/reproduce apparatus verifies the recording linear velocity that corresponds to the loaded optical disk (S604).

TABLE 1

| Version | Revision | Linear velocity for recording |
|---|---|---|
| 2.1 | 0.0 | 8.2 m/s |
| 2.1 | 1.0 | 11.4 m/s˜8.2 m/s |
| 2.1 | 2.0 | 20.5 m/s˜8.2 m/s |

Based on the results of this verification, the record/reproduce apparatus decides the linear velocity that corresponds to the optical disk that is loaded (S605). If the corresponding linear velocity for recording is held within a fixed range, the linear velocity is often decided to be the maximum value within this range. Afterward, the record/reproduce apparatus will be in a standby state until a command to record actual information is received (S606).

For a record/reproduce apparatus involved in an operation such as the above, there will be no problem in being able to determine the linear velocity if the version/revision number for the optical disk is described in the table within the record/reproduce apparatus (in other words, if the number is known). However, when a newly commercialized high recording speed optical disk that has a version/revision number that is not described in the table (in other words, is unknown) is loaded into the record/reproduce apparatus, the record/reproduce apparatus will not be able to detect the linear velocity corresponding to the optical disk. This can result in recording at an unsupported recording linear velocity by mistake.

### SUMMARY OF THE INVENTION

The present invention solves the conventional problems described above, and even when an optical disk supports recording at high recording linear velocities but does not support recording at low linear velocities is loaded into a record/reproduce apparatus that supports recording at a low linear velocity, the record/reproduce apparatus can control the recording operation appropriately and maintains a suitable signal quality the recording is being performed.

The optical information recording medium of the present invention records and/or reproduces information through irradiation with a laser light, comprising, a recording area for recording the information; and a management area for recording management information of the optical information recording medium, wherein the management area includes a recordable write-inhibit flag area. Here, at least two types of the identifying information that are independent one another and identify whether recording is prohibited or not respectively for at least two recording linear velocities are recorded in the write-inhibit flag area.

Furthermore, the management information indicates so-called specific information about the optical disk, such as address information and playback-only information, lead-in (physical format) information, and the record/reproduce conditions under which information is reproduced and written.

Moreover, depending on the mode of use, values can be indicated for two different and fixed recording linear velocities (low linear velocity and high linear velocity), there is also the case where the values change in the vicinity of these velocities and a range of velocities (a low linear velocity portion and a high linear velocity portion) is indicated.

In this way, identifying information can be recorded by the record/reproduce apparatus that will identify whether recording is prohibited or not for a particular recording linear velocity. In other words, since recording at recording linear velocities other than that corresponding to the record/reproduce apparatus can be prevented, it is possible to avoid carrying out recording with low signal quality on the medium.

In the optical information recording medium of the present invention, the management area includes a disk identification area, and the write-inhibit flag area is preferably provided within the disk identification area.

For this reason, the recording medium format structure has been simplified so that it is possible to add new identifying information to the area provided for the conventional write-inhibit flag.

In the optical information recording medium of the present invention, the disk identification area includes a plurality of recording apparatus-specific information areas where the recording apparatus information that specifies the record/reproduce apparatus is recorded, and a plurality of second write-inhibit flag areas where each of the second write-inhibit flag areas has a one-to-one correspondence with the recording apparatus-specific information areas. Here, at least two types of the second identifying information that are independent one another and identify whether recording is prohibited or not respectively for at least two recording linear velocities are recorded in the second write-inhibit flag area.

Thus, “to specify the record/reproduce apparatus” means to specify the record/reproduce conditions that are implemented in the apparatus, and the apparatus itself that can record and reproduce recording medium is not limited in any way to the specified apparatus.

In this recording medium, even at a recording linear velocity for which recording is prohibited according to the identifying information recorded in the write-inhibit flag area, if recording is permitted at a recording linear velocity in the record/reproduce apparatus according to the second identifying information recorded in a second write-inhibit flag area, then recording can be carried out at this recording linear velocity. In other words, it is possible to record with good signal quality at the maximum of the linear velocity range depending on the combination of record/reproduce apparatus and recording medium.

In the optical information recording medium of the present invention, among at least the two recording linear velocities, it is preferable that the identifying information is established so that recording is not possible in the write-inhibit flag area that manages operation of recording at the lower of the recording linear velocities, and the identifying information is established so that recording is possible in the write-inhibit flag area that manages operation of recording at the higher of the recording linear velocities.

For this reason, even if a medium that only supports high recording linear velocities is commercialized later on, it is important to be able appropriately to avoid recording on this medium by mistake by a record/reproduce apparatus that only supports a low recording linear velocity.

In the first optical information recording medium of the present invention, it is preferable that the write-inhibit flag area includes a version/revision identifier that identifies the version or revision of the optical information recording medium, and a version or revision known on the record/reproduce apparatus is recorded in the version/revision identifier.

For this reason, it is more preferable to be able to recognize the disk reliably in a conventional record/reproduce apparatus in order to be able to prevent recording by mistake more reliably.

The optical information recording method of the present invention for recording on an optical information recording medium as described above performs a recording operation based upon the identifying information and/or the second identifying information.

In this method, depending on the recording linear velocity that corresponds to the record/reproduce apparatus, by being able to control the recording operation it is possible to avoid carrying out a recording with low signal quality on the medium.

In addition, the optical information recording method of the present invention comprising, determining whether recording by the record/reproduce apparatus at the recording linear velocity is prohibited or not according to the identifying information of the write-inhibit flag area, and if the recording is determined to be prohibited, determining whether recording by the record/reproduce apparatus at the recording linear velocity is prohibited or not based on the second identifying information that corresponds to the recording apparatus information.

In this method, even if the recording is prohibited at the recording linear velocity according to the identifying information recorded in the write-inhibit flag area, if the recording is permitted in the record/reproduce apparatus at the recording linear velocity according to the second identifying information recorded in the second write-inhibit flag area, recording is performed this recording linear velocity. In other words, it is possible to record with good signal quality at the maximum of the linear velocity range depending on the combination of record/reproduce apparatus and recording medium.

Furthermore, the optical information recording method of the present invention further comprising, determining whether the recording apparatus information that corresponds to the record/reproduce apparatus and the second identifying information that corresponds to the recording apparatus information are recorded or not between the two determining performances, if the information are determined not to be recorded, performing a signal test write to be recorded by the record/reproduce apparatus at the recording linear velocity; evaluating the reproduce quality for the test write of the signal, and newly recording the recording apparatus information and the second identifying information to which the evaluation result is reflected.

In this method, the above-mentioned performances are necessary only if the recording medium is used for the first time in the record/reproduce apparatus, but they are not necessary after the second and succeeding uses. In other words, if the medium is loaded into the same record/reproduce apparatus a plurality of times, the issue of whether recording is prohibited can be determined rapidly after the second and succeeding times.

In addition, the optical information record/reproduce apparatus of the present invention for recording on an optical information recording medium as mentioned above comprises a control unit to control the recording operation based upon the identifying information and/or the second identifying information.

In this record/reproduce apparatus, depending on the recording linear velocity corresponding to the record/reproduce apparatus, by being able to control the recording operation it is possible to avoid recording with low signal quality on the medium.

In addition, in the optical information record/reproduce apparatus of the present invention, the control unit includes, a first determining unit that determines whether or not recording by the record/reproduce apparatus at the recording linear velocity is prohibited according to the identifying information of the write-inhibit flag area, and a second determining unit that determines whether or not recording by the information record/reply apparatus at the recording linear velocity is prohibited according to the second identifying information that corresponds to the recording apparatus information if the first determining unit determines that recording is prohibited.

In this record/reproduce apparatus, even if the first determining unit determines that recording is prohibited according to the identifying information recorded in the write-inhibit area, if the second determining unit determines the that recording is permissible in the record/reproduce apparatus at the recording linear velocity according to the second identifying information recorded in the second write-inhibit area, recording can be performed at this recording linear velocity. In other words, it is possible to record with good signal quality at the maximum of the linear velocity range depending on the combination of record/reproduce apparatus and recording medium.

Furthermore, in the optical information record/reproduce apparatus of the present invention, it is preferable that the control unit further includes, a third determining unit between the first determining unit and the second determining unit, where the third determining unit determines whether or not the recording apparatus information that corresponds to the record/reproduce apparatus and the second identifying information that corresponds to the record/reproduce apparatus information is recorded, a test write unit for performing a signal test write to be recorded by the record/reproduce apparatus if the third determining unit determines that there is no recording, a fourth determining unit that evaluates the reproduce quality of the signal from the test write, and an information recording unit that newly records the recording apparatus information and the second identifying information that the evaluation result of the fourth determining unit are reflected.

In this record/reproduce apparatus, the test write unit, the fourth determining unit and the information recording unit are only operated if the recording medium is used for the first time in the record/reproduce apparatus, but the operations are not performed after the second and succeeding use. In other words, if the medium is loaded into the same apparatus a plurality of times, the issue of whether recording is prohibited can be determined rapidly after the second and succeeding times.

The optical information record/reproduce apparatus of the present invention for recording on an optical information recording medium as mentioned above comprising, a spindle motor for the optical information recording medium to be rotated, an optical head that irradiates the optical information recording medium with laser light, a recording unit that controls the optical head so that recording information is recorded on the optical information recording medium, a reproduce unit for reading out the identifying information and/or the second identifying information from the optical information recording medium, a control unit to control the recording operation based on the identifying information and/or the second identifying information.

In this record/reproduce apparatus, depending on the recording linear velocity corresponding to the record/reproduce apparatus, by being able to control the recording operation it is possible to avoid recording with low signal quality on the medium.

The semiconductor circuit of the present invention that controls the recording/reproducing of the optical information recording medium as mentioned above, comprising, a control signal acquisition unit that acquires a control signal based on the identifying information and/or the second identifying information, and a parameter adjustment unit that uses the acquired control signal to adjust the parameters that control the recording operation.

For this semiconductor circuit, since the control parameters are adjusted in the semiconductor circuit using the control signal, it is possible to provide a semiconductor circuit that can establish the appropriate control parameters.

As has been mentioned above, according to the present invention, by providing an optical information recording medium with identifying information for prohibiting recording according to linear velocity depending on the recording linear velocity that corresponds to the record/reproduce apparatus, it is possible to make an appropriate determination for whether recording is prohibited or not.

### BRIEF DESCRIPTION OF THE DRAWINGS

FIG. 1 is a diagram showing the structure of an optical information recording medium related to a first embodiment of the present invention.

FIG. 2 is a diagram showing the configuration of write-inhibit flag information related to the first embodiment.

FIG. 3 is a block diagram showing the structure of an optical information record/reproduce apparatus related to the first embodiment.

FIG. 4 is a flowchart showing a recording operation related to the first embodiment.

FIG. 5 is a diagram showing a structure of an optical information recording medium related to a second embodiment of the present invention.

FIG. 6 is a diagram showing the configuration of a write-inhibit flag area and an apparatus-specific information area related to the second embodiment.

FIG. 7 is a diagram showing the structure of write-inhibit flag information related to the second embodiment.

FIG. 8 is a block diagram showing the structure of an optical information record/reproduce apparatus related to the second embodiment.

FIG. 9 is a flowchart showing a recording operation related to the second embodiment.

FIG. 10 is a diagram showing the configuration of write-inhibit flag information related to another embodiment.

FIG. 11 is a diagram showing the configuration of write-inhibit flag information related to a third embodiment of the present invention.

FIG. 12 is a flowchart showing a recording operation related to the third embodiment.

FIG. 13 is a diagram showing the configuration of write-inhibit flag information related to the third embodiment.

FIG. 14 is a flowchart showing the conventional recording operation.

### DESCRIPTION OF THE PREFERRED EMBODIMENTS

The present invention is further explained below in concrete terms using embodiments.

(First Embodiment)

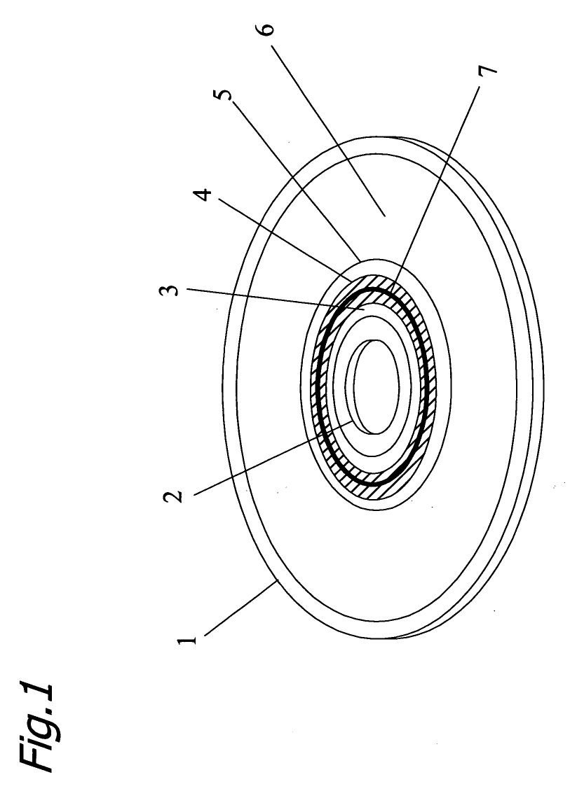

A first embodiment of the present invention is explained using FIGS. 1 through 4.

[Structure of Optical Information Recording Medium 1]

FIG. 1 shows a diagram of the structure of optical information recording medium (optical disk) 1 for the present embodiment. The structure of optical disk 1 has a recording layer provided on a transparent substrate of thickness 0.6 mm formed from polycarbonate that is provided with center-hole 2 for the purpose of attaching a record/reproduce apparatus. Not shown in the figure, the substrate is equipped with a tracking guide groove for the laser light during recording/reproducing, and address information and playback-only information recorded in an emboss bit. The recording layer is a phase-change recording material formed from a GeBiTe alloy, on which marks are formed by irradiating with laser light. This optical disk is designed to be recordable within a linear velocity range of from 24.6 m/s to 65.6 m/s with good signal quality.

Optical disk 1 includes lead-in area 3 where, for example, lead-in information for the medium is recorded by means of emboss bits, disk identification area (also called the “disk identification zone”) 4 where the recording/reproducing conditions are recorded for recording and reproducing information, test recording area 5 for use in measuring signal quality when experimentally recording specific data, and information recording area 6 where information for practical use is recorded. Disk identification area 4 is different from lead-in area 3 in that being recordable by the record/reproduce apparatus in the same way as for test recording area 5 and information recording area 6. Here, it is preferable for disk identification area 4 and test recording area 5 to be provided in between lead-in area 3 and information recording area 6. Furthermore, the area that includes lead-in area 3, disk identification area 4 and test recording area 5 is also the area that manages the operation of this record/reproduce apparatus, and is referred to as the management area.

When information is recorded on optical disk 1 of the present invention, lead-in area 3 is accessed for the first time, and the recording/reproducing conditions recorded in the area 3 are read out. Then the recording/reproducing conditions recorded in disk identification area 4 are read out, and these recording/reproducing conditions are established in the record/reproduce apparatus. Then, depending on the requirements, a test write of specific data is carried out in test recording area 5, and after the signal quality has been confirmed by reproducing the test written data, information is recorded in information recording area 6. Consequently, positioning each area as was mentioned above will result in the shortest travel distance for the optical head when recording information, and can shorten access time. Furthermore, it is satisfactory for either disk identification area 4 or test recording area 5 to be positioned at the inner circumference. In addition, it is satisfactory for any of lead-in area 3, disk identification area 4 or test recording area 5 to be positioned at the outer circumference of information recording area 6.

Write-inhibit flag area 7 is provided within disk identification area 4. This area 7 could also be provided within lead-in area 3 to obtain the effect of appropriately controlling the write-inhibit operation, but providing area 7 within disk identification area 4 has the advantage that the identifying information within write-inhibit flag area 7 is rewritable by the user's record/reproduce apparatus, which is more preferable. Additionally, if area 7 is provided within disk identification area 4, the format configuration of the optical disk becomes simpler so that new identifying information can be added to the area that provides identifying information on the recording operation, which is more preferable. In either case, it is desirable for the identifying information to be located in an area that will be reproduced prior to any actual information being recorded.

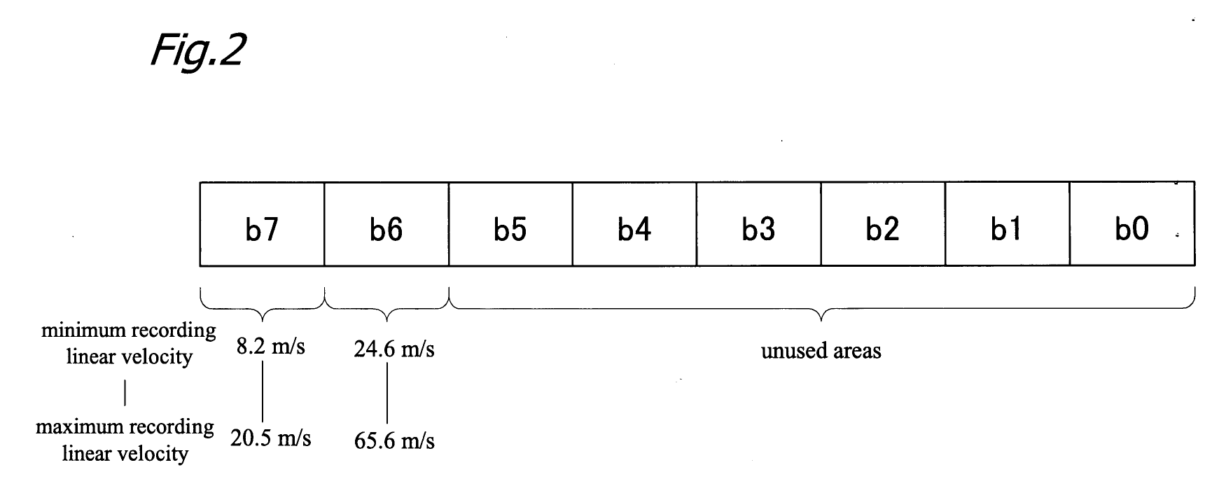

FIG. 2 is a diagram that explains the configuration of the write-inhibit flag information that is recorded in write-inhibit flag area 7 in the first embodiment of the present invention.

The write-inhibit flag information comprises an area of 1 byte (specifically, 8 bits). The highest-order bit b7 records the write-inhibit identifying information for the linear velocity range of from 8.2 m/s to 20.5 m/s. The next bit b6 records the identifying information for the linear velocity range of from 24.6 m/s to 65.6 m/s. Bits from b5 to b0 are unused areas.

When identifying information bits b7 and b6 have the bit status “1”, recording is prohibited in information recording area 6. If the bit status is “0”, recording to information recording area 6 is permitted.

Optical disk 1 is different from the conventional system in that a bit is provided in write-inhibit flag area 7 for recording write-inhibit identifying information according to the linear velocity.

In the present embodiment, optical disk 1 is designed to be recordable with good signal quality in the linear velocity range of from 24.6 m/s to 65.6 m/s after recording a bit status of “1” for b7 and a “0” for b6 in write-inhibit flag area 7 beforehand.

The abovementioned linear velocity range is established so that the ratio of a minimum linear velocity to maximum linear velocity is approximately 2.6. When an optical disk with a diameter of 12 cm, the ratio value is derived from the parameter of the disk that a radius from the center to the innermost circumference is approximately 23 mm and a radius from the center to the outermost circumference is approximately 59 mm.

[Structure of the Optical Information Record/Reproduce Apparatus]

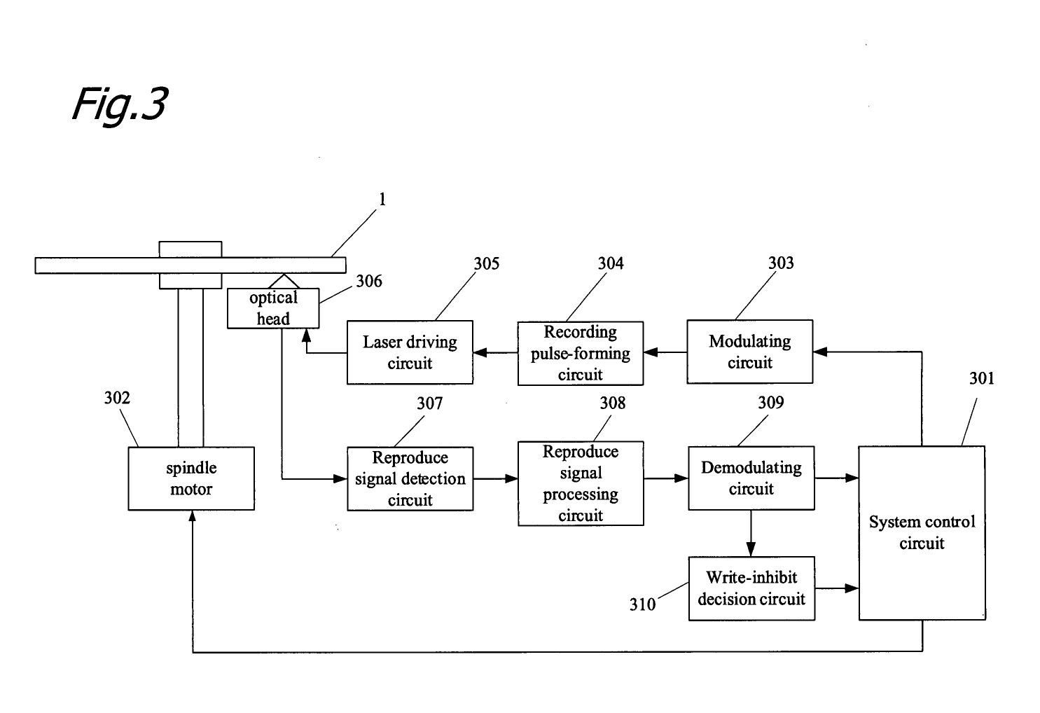

FIG. 3 is a block diagram that shows a structure schematic of the optical information record/reproduce apparatus (record/reproduce apparatus) in the present embodiment. The present embodiment uses two units, namely record/reproduce apparatus A in which information can be recorded at a linear velocity of 8.2 m/s and record/reproduce apparatus B in which information can be recorded at a linear velocity of 65.6 m/s.

Record/reproduce apparatuses A and B are respectively controlled by system control circuit 301. Optical disk 1 is rotated by spindle motor 302. Modulating circuit 303 modulates the information during actual recording. Recording pulse-forming circuit 304 forms a recording pulse signal based on the modulated signal from modulating circuit 303. Laser driving circuit 305 drives the laser based upon the recording pulse signal. Optical head 306 radiates laser light from the driven laser onto optical disk 1. The modulating circuit 303, recording pulse-forming circuit 304 and laser driving circuit 305 are all referred to as recording units.

Reproduce signal detection circuit 307 detects the reproduce signal based on the reflected light from optical disk 1 as an electric signal. Reproduce signal processing circuit 308 carries out conversions of the reproduce signal such as binarization and waveform equalization. Demodulating circuit 309 demodulates the information. The reproduce signal detection circuit 307, reproduce signal processing circuit 308 and demodulating circuit 309 are all referred to as reproduce units. Write-inhibit decision circuit 310 detects the identifying information in write-inhibit flag area 7 and determines whether recording is prohibited or not.

Furthermore, the circuit functions are explained separately as shown in FIG. 3, but there is no necessary one-to-one correspondence between these functions and circuits. In other words, any arbitrary circuits can be used that are designed for implementing the record/reproduce apparatus of the present embodiment. For example, it is also satisfactory to execute these functions in semiconductor circuits that combine certain of the above-described circuits, and it is also satisfactory to combine the functions of the write-inhibit decision circuit 310 within system control circuit 301.

[Recording Operation]

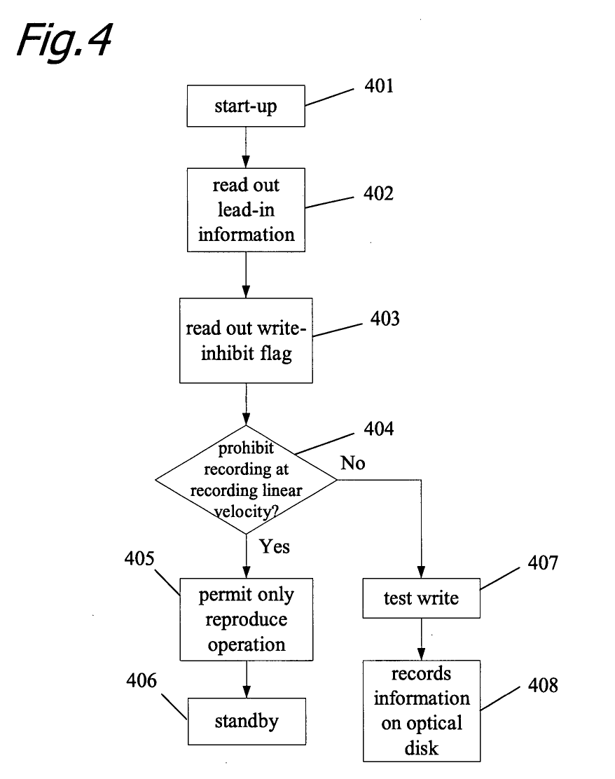

Next, the flowchart in FIG. 4 is used to explain the operation of the record/reproduce apparatus of the present embodiment. The operation will be explained for when optical disk 1 is loaded into record/reproduce apparatus A for the first time.

After loading optical disk 1, firstly, in start-up step 401 (abbreviated below as S401), system control circuit 301 sets the rotation speed for spindle motor 302, and optical disk 1 is rotated at the specified linear velocity (8.2 m/s in record/reproduce apparatus A). Laser driving circuit 305 irradiates optical disk 1 with laser light, and system control circuit 301 controls the actuator for optical head 306 and carries out the focusing and tracking operations. Then, optical head 306 is transported to lead-in area 3 of optical disk 1.

In lead-in information read out step S402, the information recorded on optical disk 1 is read out. Here, changes in the amount of light reflected from optical disk 1 are detected as an electric signal by reproduce signal detection circuit 307, the electric signal is demodulated by straightforward waveform processing in reproduce signal processing circuit 308, and the information signal is obtained in demodulating circuit 309.

Continuing, the identifying information from write-inhibit flag area 7 is read out in write-inhibit flag read out step S403.

Then, in write-inhibit determination step S404, a determination is made by write-inhibit decision circuit 310 for whether recording is prohibited or not at the linear velocity corresponding to record/reproduce apparatus A (specifically, 8.2 m/s). The identifying information from the write-inhibit flag that corresponds to a recording linear velocity of 8.2 m/s corresponds to the bit b7 in FIG. 2. Here, with b7 having a bit status of “1”, write-inhibit decision circuit 310 will determine that recording is prohibited in this record/reproduce apparatus (a “yes” for S404).

Based on this determination result, in reproduce permission step S405, system control circuit 301 sends a signal to permit only a reproduce operation to modulating circuit 303, recording information is not sent to modulating circuit 303. In standby step S406, record/reproduce apparatus A will be in standby mode until system control circuit 301 indicates that information from optical disk 1 is to be reproduced.

In the above steps, record/reproduce apparatus A can record well to optical disk 1 within the linear velocity range of from 24.6 m/s to 65.6 m/s, it is prohibited from being able to record at a linear velocity of 8.2 m/s. This has the effect of making it possible to prevent recording to optical disk 1 under conditions where the signal quality would be low.

Next, the operation will be explained for when optical disk 1 is loaded into record/reproduce apparatus B. Up to the write-inhibit flag read out step S403, the process is the same as for record/reproduce apparatus A except that optical disk 1 is rotated at a linear velocity of 65.6 m/s.

In write-inhibit determination step S404, a determination is made by write-inhibit decision circuit 310 for whether recording is prohibited or not at the linear velocity corresponding to record/reproduce apparatus B (specifically, 65.6 m/s). The identifying information from the write-inhibit flag that corresponds to a recording linear velocity of 65.6 m/s corresponds to the bit b6 in FIG. 2. Here, with b6 having a bit status of “0”, write-inhibit decision circuit 310 will determine that recording is permitted in record/reproduce apparatus B (a “no” for S404).

Based on this determination result, in test write step S407, system control circuit 301 sends test write information to modulating circuit 303, and a test write is performed on optical disk 1. Depending on the results from the test write, conditions (specifically, recording power, erasing power, recording pulse waveform and the like) for recording to optical disk 1 are decided. In recording step S408, system control circuit 301 records information to optical disk 1.

In the above steps, record/reproduce apparatus B can record well from optical disk 1 within the range of from 24.6 m/s to 65.6 m/s, and is able to record at a linear velocity of 65.6 m/s.

As was mentioned above, the point of the present embodiment, as shown in FIG. 2, is that write-inhibit flag identifying information is provided according to the linear velocity. As a result, depending on the recording linear velocity that corresponds to the record/reproduce apparatus, an appropriate determination can be made as to whether recording is prohibited or not. In other words, since it is possible to prevent recording at a recording linear velocity that is not supported by the record/reproduce apparatus, carrying out recording on the medium with a low signal quality can be avoided.

(Second Embodiment)

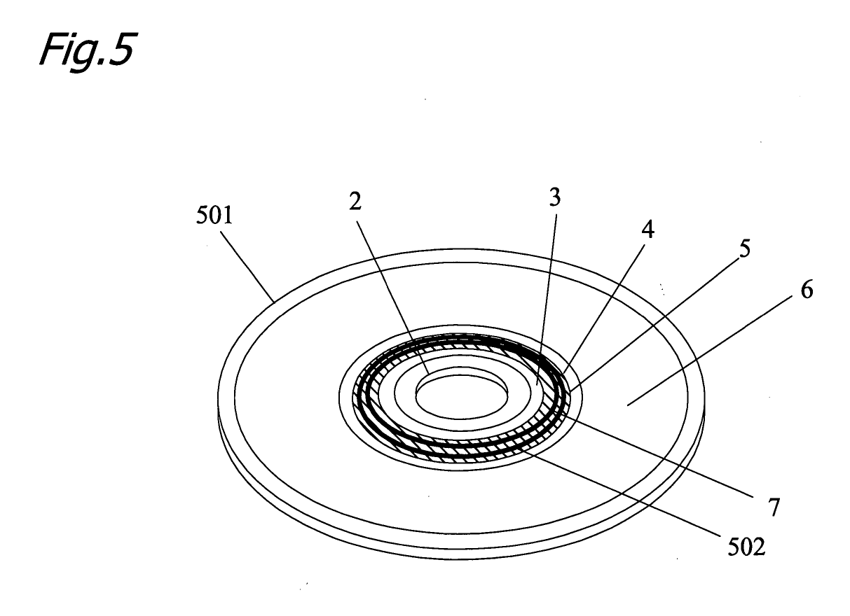

Next, a second embodiment of the present invention will be explained using FIGS. 5 through 9.

[Structure of Optical Information Recording Medium 501]

FIG. 5 shows a diagram of the structure of optical information recording medium (optical disk) 501 for the present embodiment. A difference compared to the first embodiment is that information areas specific to the recording apparatus (apparatus-specific information areas) 502 are provided within disk identification area 4. Moreover, optical disk 501 is designed to be recordable within the linear velocity range of from 24.6 m/s to 65.6 m/s with good signal quality. However, optical disk 501 was designed to have a good recording performance range that is somewhat broader when compared to the first embodiment. For this reason, if the record/reproduce apparatus has good performance, there is a possibility that good recording can be carried out even at a linear velocity of 20.5 m/s.

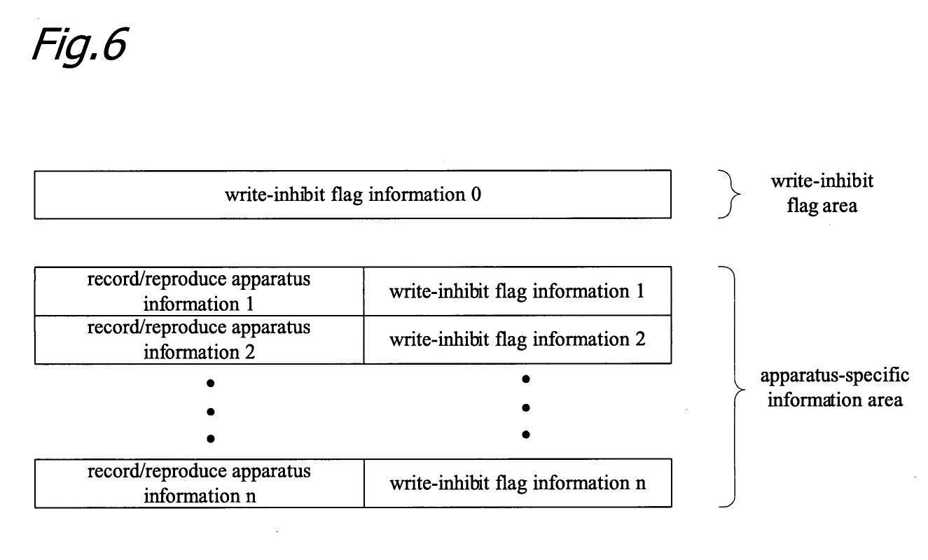

FIG. 6 is a diagram that shows the configuration of the information recorded in write-inhibit flag area 7 and apparatus-specific information area 502 for the present embodiment. A difference from the first embodiment is that the corresponding information that shows the specific record/reproduce apparatus is recordable write-inhibit flag information in apparatus-specific information area 502.

Here, the identifying information recorded in write-inhibit flag area 7 is referred to as “write-inhibit flag information 0”. For the information showing n units of record/reproduce apparatus in apparatus-specific information area 502, n units of write-inhibit flag information can be recorded. These are respectively referred to as “record/reproduce apparatus information n” and “write-inhibit flag information n” (here n is an integer ≧1). There is a one-to-one correspondence between the same numbers for the record/reproduce apparatus information and the write-inhibit flag information.

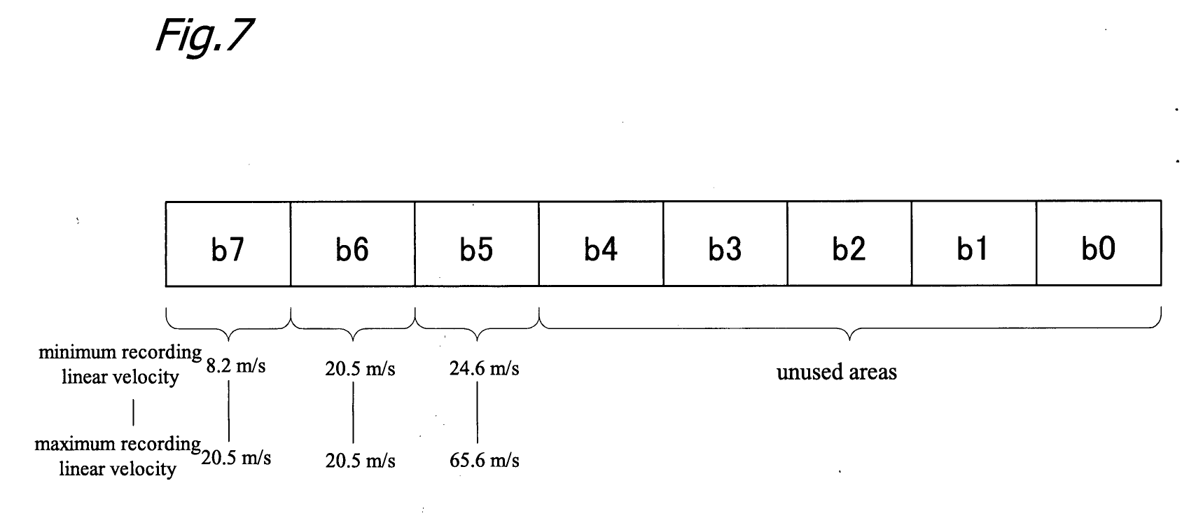

FIG. 7 is a diagram that shows the configuration of the write-inhibit flag information recorded in write-inhibit flag area 7 and apparatus-specific information area 502 for the present embodiment.

In the present embodiment, the highest-order bit b7 records the write-inhibit identifying information for the linear velocity range of from 8.2 m/s to 20.5 m/s. The next bit b6 records the identifying information for the linear velocity 20.5 m/s. The next bit b5 records the identifying information for the linear velocity range of from 24.6 m/s to 65.6 n/s. Bits b4 through b0 are unused areas.

For bits b7, b6 and b5, the relationship between bit status and recording prohibition/permission are the same as in the first embodiment. If the bit status is “0”, recording to information recording area 6 is permitted.

Optical disk 501 is designed to be recordable with good signal quality within the linear velocity range of from 24.6 m/s to 65.6 m/s at a minimum. For this reason, a bit status of “1” for b7, “1” for b6 and “0” for b5 is recorded in “write-inhibit flag information 0” for the previous write-inhibit flag area 7 identifying information. Furthermore, when shipping optical disk 501, no specific information is recorded in apparatus-specific information area 502 in other words, the area should be completely blank).

[Structure of the Optical Information Record/Reproduce Apparatus]

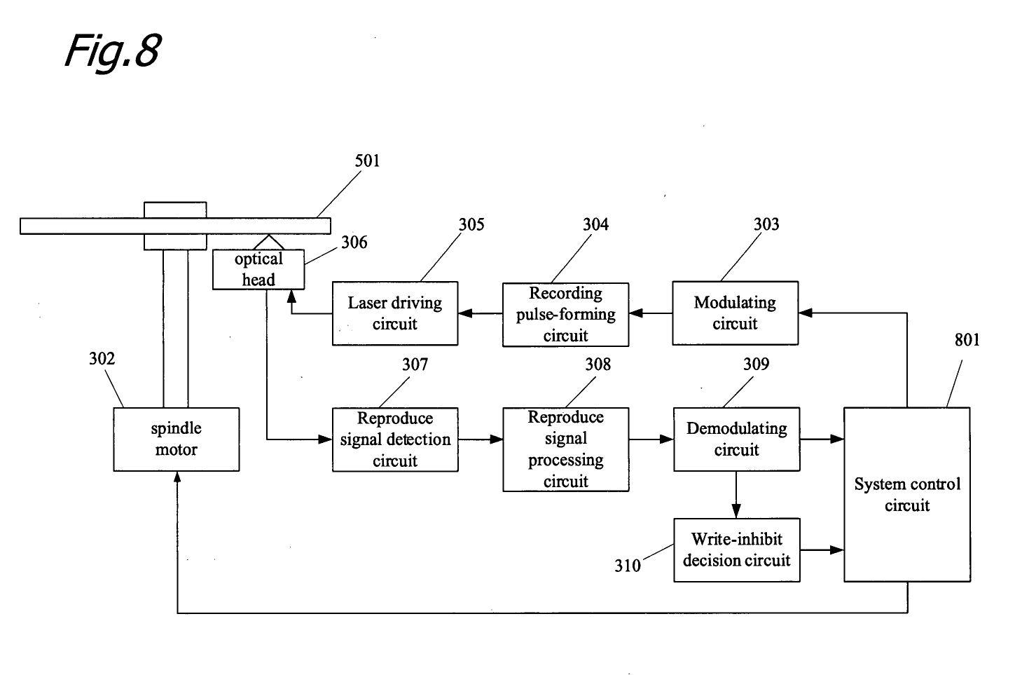

FIG. 8 shows a structure schematic of the optical information record/reproduce apparatus in the present embodiment. This differs from the record/reply apparatus of the first embodiment in that optical disk 501 is used, and the operation of system control circuit 801 is different.

The present embodiment uses three units, namely record/reproduce apparatus A in which information can be recorded at a linear velocity of 8.2 m/s, record/reproduce apparatus B in which information can be recorded at a linear velocity of 65.6 m/s and record/reproduce apparatus C in which information can be recorded at a linear velocity of 20.5 m/s.

[Recording Operation]

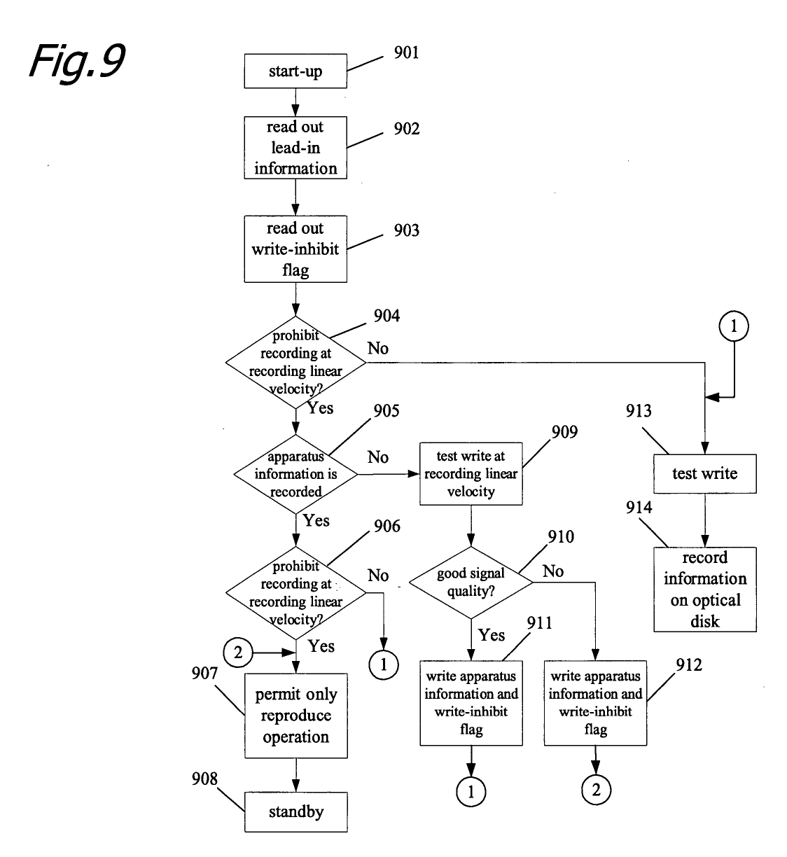

Next, the flowchart in FIG. 9 is used to explain the operation of the record/reproduce apparatus of the present embodiment. The operation will be explained for when optical disk 501 is loaded into record/reproduce apparatus A for the first time.

After optical disk 501 has been loaded, start-up step S901 and lead-in information read out step S902 are the same as for start-up step S401 and lead-in information read out step S402 of the first embodiment. Continuing, “write-inhibit flag information 0” for the identifying information in write-inhibit flag area 7, and “record/reply apparatus information n” and “write-inhibit flag information n” from apparatus-specific information area 502 (where n is an integer ≧1) are read out in write-inhibit flag read out step S903.

In write-inhibit determination step S904, “write-inhibit flag information 0” is used to determine whether recording is prohibited or not at the linear velocity (specifically, 8.2 m/s) supported for recording in record/reproduce apparatus A. The identifying information of the write-inhibit flag that corresponds to a recording linear velocity of 8.2 m/s corresponds to the bit b7 in FIG. 7. For this optical disk 501 with b7 having a bit status of “1”, write-inhibit decision. circuit 310 will determine that recording is prohibited in the record/reproduce apparatus (a “yes” for S904).

Next, apparatus-specific information area 502 is checked for the presence or absence of information that specifies record/reproduce apparatus A in apparatus information determination step S905.

When optical disk 501 is loaded into record/reproduce apparatus A for the first time, information that specifies record/reproduce apparatus A will be absent (a “no” for S905). In this case, after a test write is carried out at a linear velocity of 8.2 m/s in test write step S909, the signal quality of the reproduced data from the test write is determined in signal quality determination step S910. Since optical disk 501 cannot be recorded well at a linear velocity of 8.2 m/s, the signal quality is determined to be NG (not good) (a “no” for S910). In information write step S912, from among “record/reproduce apparatus information n” and “write-inhibit flag information n” (where n is an integer ≧1) in apparatus-specific information area 502, information that specifies record/reproduce apparatus A and the write-inhibit flag identifying information is written in the empty area. Moreover, if apparatus-specific information area 502 is completely empty, it is best to record the information as “record/reproduce apparatus information 1” and “write-inhibit flag information 1”. Since it is not possible to carry out good recording at 8.2 m/s in record/reproduce apparatus A, a bit status of “1” is recorded for the write-inhibit flag information bit b7 (see FIG. 7). If a bit status of “write-inhibit flag information 0” is copied and recorded for bits b6 and b5, they will have a blank recording status. In reproduce permission step S907, system control circuit 801 sends a signal permitting only the reproduce operation to modulating circuit 303, recording information is not sent to modulating circuit 303. In standby step S908, record/reproduce apparatus A will be in standby mode until system control circuit 801 indicates that information from the optical disk is to be reproduced.

If optical disk 501 has been loaded into record/reproduce apparatus A two or more times, the information that specifies record/reproduce apparatus A will already have been recorded in apparatus-specific information area 502 (a “yes” for S905). In this case, based on the identifying information of “write-inhibit flag information n” that corresponds to the “record/reproduce apparatus information n” recorded as the information that specifies record/reproduce apparatus A, it is determined whether or not recording at a linear velocity of 8.2 m/s is prohibited (S906). Since a “1” is set as the write-inhibit flag information for bit b7, it is determined that recording at a linear velocity of 8.2 m/s is prohibited (a “yes” for S906). Consequently, in reproduce permission step S907, system control circuit 801 sends a signal to modulating circuit 303 permitting only the reproduce operation, recording information is not sent to modulating circuit 303. In standby step S908, record/reproduce apparatus A will be in standby mode until system control circuit 801 indicates that information from optical disk 501 is to be reproduced. In this way, if optical disk 501 is loaded two or more times, the system need not go through a test write, and can determine quickly whether recording is prohibited or not.

By following the above steps, record/reproduce apparatus A will be able to determine that recording on optical disk 501 is prohibited at a linear velocity of 8.2 m/s. This has the effect of making it possible to prevent recording to optical disk 501 under conditions where the signal quality would be low.

Next, the operation will be explained for when optical disk 501 is introduced into record/reproduce apparatus B. Up to the write-inhibit flag read out step S903, the process is the same as for record/reproduce apparatus A except that optical disk 501 is rotated at a linear velocity of 65.6 m/s.

According to write-inhibit determination step S904, a determination is made by write-inhibit decision circuit 310 for whether recording is prohibited or not at the linear velocity corresponding to record/reproduce apparatus B (specifically, 65.6 m/s). The identifying information from the write-inhibit flag that corresponds to a recording linear velocity of 65.6 m/s corresponds to the bit b5 in FIG. 7. With b6 having a bit status of “0” for, write-inhibit decision circuit 310 will determine that recording is permitted in record/reproduce apparatus B (a “no” for S904).

Based on this determination result, according to test write step S913, system control circuit 801 sends test write information to modulating circuit 303, and a test write is performed on optical disk 501.

Depending on the results from the test write, conditions (specifically, recording power, erasing power, recording pulse waveform and the like) for recording to optical disk 501 are decided. In recording step S914, system control circuit 801 records information to optical disk 501.

By following the above steps, record/reproduce apparatus B can record to optical disk 501 at a linear velocity of 65.6 m/s.

Next, the operation will be explained for when optical disk 501 is introduced into record/reproduce apparatus C. Up to the write-inhibit flag read out step S903, the process is the same as for record/reproduce apparatus A except that optical disk 501 is rotated at a linear velocity of 20.5 m/s.

According to write-inhibit determination step S904, “write-inhibit flag information 0” is used to determine whether recording is prohibited or not at the linear velocity (specifically, 20.5 m/s) supported for recording in record/reproduce apparatus C. Identifying information for the record-prohibit flag corresponding to a recording linear velocity of 20.5 m/s correspond to bits b7 and b6 in FIG. 7. For this optical disk 501 with a bit status of “1” for b7 and b6, write-inhibit decision circuit 310 will determine that recording is prohibited in this record/reproduce apparatus (a “yes” for S904). Next, apparatus-specific information area 502 is checked for the presence or absence of information that specifies record/reproduce apparatus C in apparatus information determination step S905.

When optical disk 501 is loaded into record/reproduce apparatus C for the first time, information that specifies record/reproduce apparatus C will be absent (a “no” for S905). In this case, after a test write is carried out at a linear velocity of 20.5 m/s in test write step S909, the signal quality of the reproduced data from the test write is determined in signal quality determination step S910. If the performance of record/reproduce apparatus C is good, recording of good quality to optical disk 501 can be performed at a linear velocity of 20.5 m/s. This will result in a determination of OK for the signal quality (a “yes” for S910). In information write step S912, from among “record/reproduce apparatus information n” and “write-inhibit flag information n” (where n is an integer ≧1) in apparatus-specific information area 502, information that specifies record/reproduce apparatus C and the write-inhibit flag identifying information is written in the empty area. Since good quality recording is possible at 20.5 m/s in record/reproduce apparatus C, a bit status of “0” is set and recorded for write-inhibit flag information bit b6 (see FIG. 7). If a bit status of “write-inhibit flag information 0” is copied and recorded for bits b7 and b5, they will have a blank recording status. Bit b7 is not set to “0” here since b7 is set to a bit status of “0” only if recording of good quality can be carried out throughout the entire linear velocity range of from 8.2 m/s to 20.5 m/s, so that a test write will not be performed in record/reproduce apparatus C at any linear velocity except 20.5 m/s.

If good quality recording cannot be carried out by record/reproduce apparatus C at 20.5 m/s, a determination of “no” will be made in S910. The following steps are the same as for record/reproduce apparatus A. Additionally, if optical disk 501 is loaded two or more times, the system need not go through a test write and can determine quickly whether recording is prohibited or not, just as in the case of record/reproduce apparatus A.

By following the above steps, record/reproduce apparatus C will be able to determine appropriately whether recording on optical disk 501 at a linear velocity of 20.5 m/s is prohibited or not.

As has been mentioned above and as shown for the present embodiment in FIG. 6, record/reproduce apparatus information 1 through n that specify the record/reproduce apparatus together with write-inhibit information 1 through n that have a one-to-one correspondence with the record/reproduce apparatus information are recorded in the apparatus-specific information area 502 of optical disk 501. In this way, through combinations of record/reproduce apparatus performance with optical disks, it will be possible to carry out good quality recording over a greater range of linear velocities. In concrete terms, even at recording linear velocities for which recording is prohibited by a write-inhibit flag information 0 recorded in write-inhibit flag area 7, if there is a linear velocity for the record/reproduce apparatus permissible by write-inhibit flag information 1 through n recorded in apparatus-specific information area 502, recording can be performed at this linear velocity.

Furthermore, in the present embodiment, with S904 determining whether recording is prohibited or not at a linear velocity that corresponds to the record/reproduce apparatus according to write-inhibit flag information 0 recorded in write-inhibit flag area 7, if recording is determined by S904 to be prohibited, between this step and S906 in which it is determined whether recording is prohibited or not at a linear velocity for the record/reproduce apparatus according to write-inhibit flag information corresponding to the record/reproduce apparatus information, the additional steps S905, S909, S910, S911 and S912 are provided. In concrete terms, S905 determines whether to record or not based on record/reproduce apparatus information that corresponds to the record/reproduce apparatus and write-inhibit flag information (1 through n) corresponding to the record/reproduce apparatus information, and in that case that it is determined here that recording cannot take place, S909 performs a test write on optical disk 501, S910 determines the reproduce quality of the test write signal, and for the determination result from S910, S911 and S912 are provided to record the record/reproduce apparatus information and the write-inhibit flag information (1 through n).

In this method, steps S909, S910, S911 and S912 are necessary only if optical disk 501 is used in this record/reproduce apparatus for the first time, and these steps are not necessary for the second and succeeding times. In other words, if the optical disk is loaded into the same record/reproduce apparatus a plurality of times, the issue of whether recording is prohibited can be determined rapidly after the second and succeeding times.

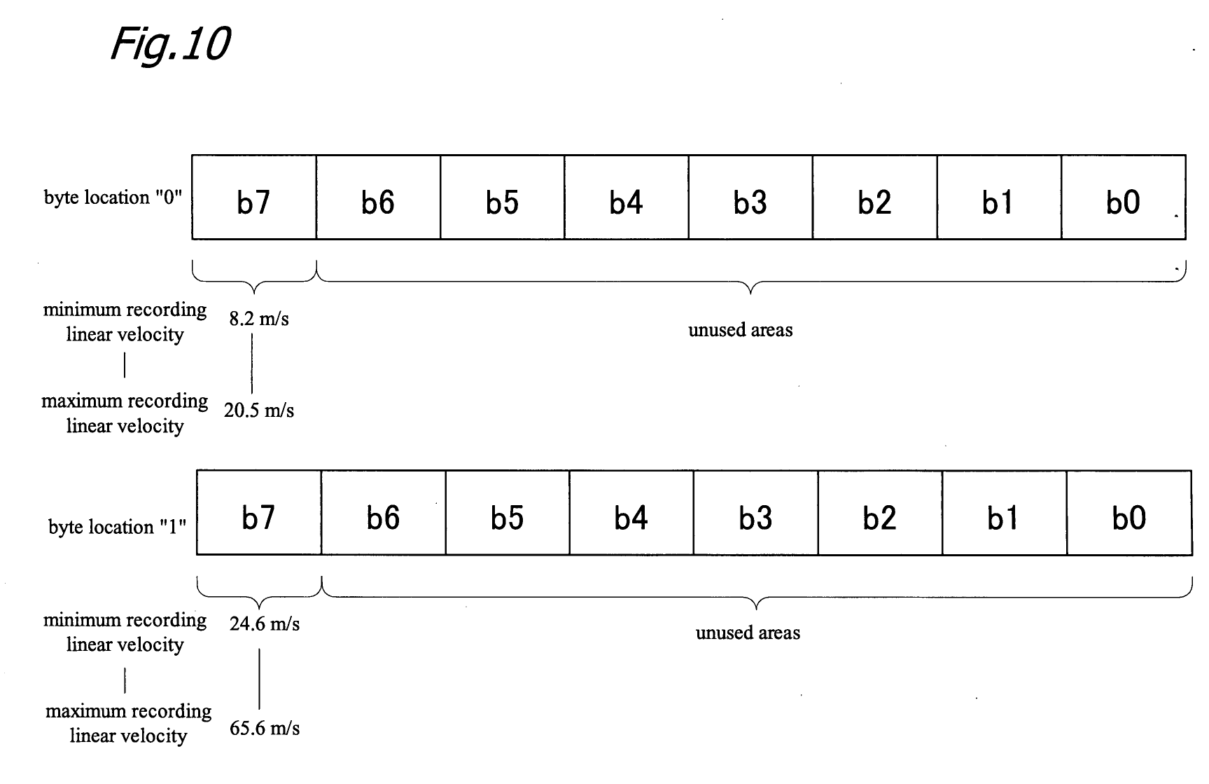

Furthermore, in each of the above embodiments, the write-inhibit flag information for individual linear velocities is assigned to each bit within 1 byte, but the same result can also be obtained when each linear velocity is assigned to a separate byte, as shown in FIG. 10. In the mode shown in FIG. 10, the highest-order bit b7 of byte location “0” records the write-inhibit identifying information in the linear velocity range of from 8.2 m/s to 20.5 m/s. Moreover, the highest-order bit b7 of byte location “1” records the identifying information in the linear velocity range of from 24.6 m/s to 65.6 m/s. Each of the bits b6 to b0 is unused areas.

(Third Embodiment)

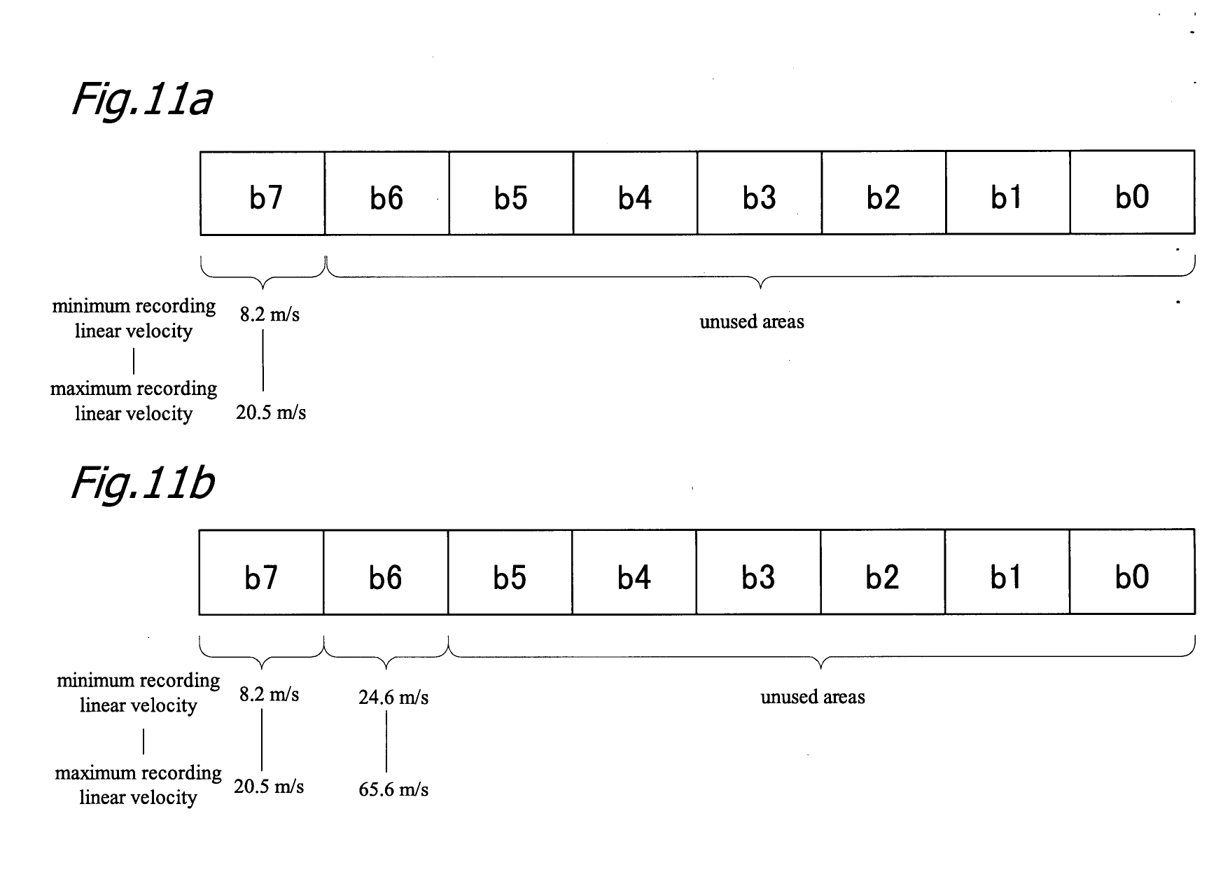

Next, a third embodiment of the present invention is explained using FIGS. 11 through 13. Furthermore, the portions of the configuration that are the same as in the abovementioned embodiments are omitted from the explanation.

[Structure of the Optical Information Recording Medium]

The structure of the optical information recording medium (optical disk) of the present embodiment is the same as that used in the first embodiment (see FIG. 1)

FIG. 11 shows the configuration of the write-inhibit flag information recorded in write-inhibit flag area 7 of the present embodiment. FIG. 11a shows the case of an optical disk (referred to as disk A) that corresponds to recording within the linear velocity range of from 8.2 m/s to 20.5 m/s, and FIG. 11b shows the case of a higher velocity optical disk (referred to as disk B) that corresponds to recording within the linear velocity range of from 24.6 m/s to 65.6 m/s.

The write-inhibit flag information comprises an area of 1 byte (in other words 8 bits).

In disk A, the highest-order bit b7 records the write-inhibit identifying information for the linear velocity range of from 8.2 m/s to 20.5 m/s. Bits b6 through b0 are unused areas.

In disk B, the highest-order bit b7 records the write-inhibit identifying information for the linear velocity range of from 8.2 m/s to 20.5 m/s, in the same way as for disk A. The next bit b6 is different from that in disk A in that it records the write-inhibit identifying information for the linear velocity range of from 24.6 m/s to 65.6 m/s. Bits b5 through b0 are unused areas.

When the identifying information bit b7 in disks A and B and the identifying information bit b6 in disk B have a bit status of “1”, recording in information recording area 6 is prohibited. If the bit status is “0”, recording to information recording area 6 is permitted.

The optical disk of the present embodiment is different from the conventional system in that a bit is provided in write-inhibit flag area 7 for recording write-inhibit identifying information according to the linear velocity.

For disk A of the present embodiment, since optical disk 1 is designed to be recordable with good signal quality within the linear velocity range of from 8.2 m/s to 20.5 m/s, a bit status of “0” for b7 will be recorded in write-inhibit flag area 7 beforehand. For disk B, since optical disk 1 is designed to be recordable with good signal quality within the linear velocity range from 24.6 m/s to 65.6 m/s, a bit status of “1” for b7 and a bit status of “0” for b6 are recorded in write-inhibit flag area 7.

[Structure of the Optical Information Record/Reproduce Apparatus]

The structure schematic of the optical information record/reproduce apparatus (record/reproduce apparatus) for the present embodiment is the same as that in the first embodiment (see FIG. 3).

The present embodiment uses two units, namely record/reproduce apparatus A in which information can be recorded within a linear velocity range of from 8.2 m/s to 20.5 m/s, and record/reproduce apparatus B in which information can be recorded within a linear velocity range of from 8.2 m/s to 65.6 m/s.

[Recording Operation]

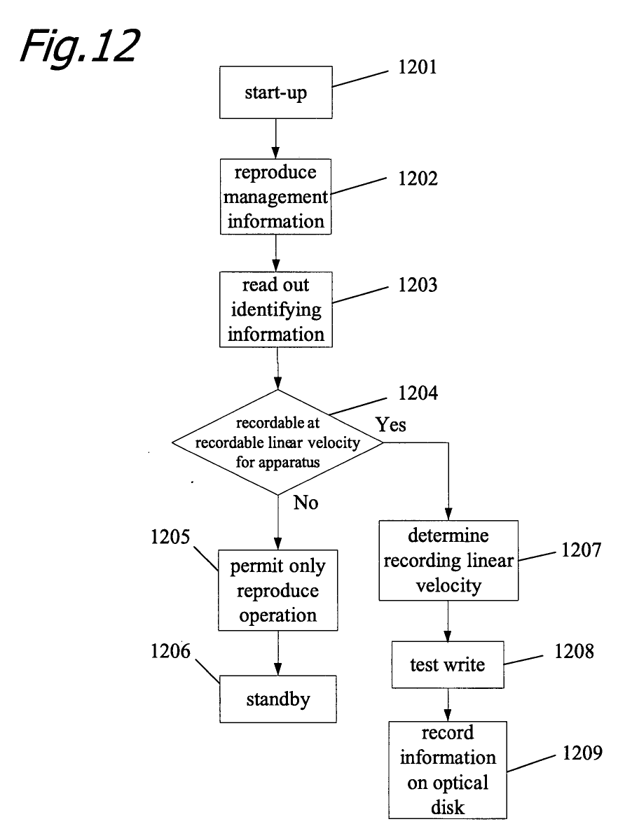

Next, the flowchart in FIG. 12 is used to explain the operation of the record/reproduce apparatus of the present embodiment. The operation will be explained for when optical disk 1 is loaded into record/reproduce apparatus A for the first time.

After introducing optical disk 1, firstly, in start-up step S1201, system control circuit 301 sets the rotation speed for spindle motor 302, and optical disk 1 is rotated at the specified linear velocity (20.5 m/s in record/reproduce apparatus A). Laser driving circuit 305 irradiates optical disk 1 with laser light, and system control circuit 301 controls the actuator for optical head 306 and carries out the focusing and tracking operations. Then, optical head 306 is transported to the management area of optical disk 1.

In management information reproduce step S 1202, the reproduce of the management information recorded on disk 1 is initiated. Here, changes in the amount of light reflected from optical disk 1 are detected as an electric signal by reproduce signal detection circuit 307, the electric signal is demodulated by straightforward waveform processing in reproduce signal processing circuit 308, and the information signal is obtained in demodulation circuit 309.

Continuing, the identifying information in write-inhibit flag area 7 is read out in identifying information read out step S1203.

In recordable linear velocity determination step S1204, a determination is made by write-inhibit decision circuit 310 of whether recording is prohibited or not at a linear velocity that is recordable for record/reproduce apparatus A (specifically, from 8.2 m/s to 20.5 m/s).

The identifying information in write-inhibit flag area 7 (that corresponds to a recording linear velocity of from 8.2 m/s to 20.5 m/s corresponds to bit b7 in FIGS. 11a and 11b. By managing this bit b7, record/reproduce apparatus A can reproduce the management information for managing the operation of this apparatus. In other words, the format of optical disk A is taken from what was present at the point in time when record/reproduce apparatus A was commercialized. However, since the format of optical disk B did not exist at that time], bit b6 cannot manage the operation of this apparatus, and record/reproduce apparatus B cannot manage bit b6.

When optical disk A is loaded, since the bit status of b7 will be “0” (in other words, that said optical disk is recordable over linear velocities of from 8.2 m/s to 20.5 m/s), write-inhibit decision circuit 310 determines that recording on this record/reproduce apparatus is permissible (a “yes” for S1204).

Based on this determination result, recording linear velocity-determining step S1207 decides the recording linear velocity that corresponds to the loaded disk. Since the maximum recordable linear velocity for the combination of this record/reproduce apparatus A and optical disk A is 20.5 m/s, this step decides on 20.5 m/s as the recording linear velocity. According to test write step S1208, system control circuit 301 sends the test write information to modulating circuit 303, and performs the test write on optical disk A. Depending on the results from the test write, conditions (specifically, recording power, erasing power, recording pulse waveform and the like) for recording to optical disk A will be decided. According to recording step S1209, when the indication to record information arrives, system control circuit 301 records the information on optical disk A.

When optical disk B is loaded into record/reproduce apparatus A, since the bit status of b7 will be “1”, write-inhibit decision circuit 310 determines that recording on record/reproduce apparatus A is prohibited (a “no” for S1204).

Based on this determination result, according to reproduce permission step S1205, system control circuit 301 sends a signal to modulating circuit 303 to permit only a reproduce operation, and recording information is not sent to modulating circuit 303. According to standby step S1206, record/reproduce apparatus A will be in standby mode until system control circuit 301 indicates that information from optical disk B is to be reproduced.

According to the above steps, record/reproduce apparatus A can record to disk A without any problems, it will appropriately be prohibited from recording to disk B. This has the effect of making it possible to prevent recording to optical disk 1 under conditions where the signal quality would be low.

Next, the operation will be explained when optical disk 1 is loaded into record/reproduce apparatus B. Up to the write-inhibit flag read out step S1203, the process is the same as for record/reproduce apparatus A except that optical disk 1 is rotated at a linear velocity of 65.6 m/s.

In recordable linear velocity determination step S1204, a determination is made by write-inhibit decision circuit 310 of whether recording is prohibited or not at a linear velocity that is recordable for record/reproduce apparatus B (specifically, from 8.2 m/s to 65.6 m/s).

The identifying information in write-inhibit flag area 7 that corresponds to a recording linear velocity of from 8.2 m/s to 20.5 m/s corresponds to bit b7 in FIGS. 11a and 11b. Additionally, the identifying information in write-inhibit flag area 7 that corresponds to a recording linear velocity of from 24.6 m/s to 65.6m/s corresponds to bit b6 in FIGS. 11a and 11b. By managing both of these bits b7 and b6, record/reproduce apparatus B can reproduce the management information for managing the operation of record/reproduce apparatus B. In other words, the formats of both optical disk A and optical disk B are taken from what was present at the point in time when record/reproduce apparatus B was commercialized.

When optical disk A is loaded, record/reproduce apparatus B detects a bit status of “0” for b7 (in other words, a recordable linear velocity range of from 8.2 m/s to 20.5 m/s). As a result, write-inhibit decision circuit 310 determines that recording on this record/reproduce apparatus is permissible (a “yes” for S1204).

Based on this determination result, recording linear velocity-determining step S1207 decides the recording linear velocity that corresponds to the loaded disk. Since linear velocities of from 8.2 m/s to 65.6 m/s are recordable and disk A is recordable at a maximum linear velocity of 20.5 m/s, record/reproduce apparatus B decides on a recording linear velocity of 20.5 m/s. According to test write step S1208, system control circuit 301 sends the test write information to modulating circuit 303, and performs the test write on optical disk A. Depending on the results from the test write, conditions (specifically, recording power, erasing power, recording pulse waveform and the like) for recording to optical disk A are decided. According to recording step S1209, when the indication to record information arrives, the system control circuit records the information on optical disk A.

When optical disk B is loaded into record/reproduce apparatus A, since the bit status of b6 will be “0” (in other words, a recordable linear velocity range of from 24.6 m/s to 65.6 m/s), write-inhibit decision circuit 310 determines that recording in record/reproduce apparatus A is permissible (a “yes” for S1204), the same as for disk A.

Based on this determination result, recording linear velocity-determining step S1207 decides the recording linear velocity that corresponds to the loaded disk. Since linear velocities of from 8.2 m/s to 65.6 m/s are recordable and disk A is recordable at a maximum linear velocity of 65.6 m/s, this record/reproduce apparatus A decides on a recording linear velocity of 65.6 m/s. The steps hereafter are the same as those for disk A, except that the recording linear velocity is set at 65.6 m/s.

According to the above steps, record/reproduce apparatus B is able to record to either of disks A or B at the maximum linear velocity that corresponds to each disk.

As was mentioned above and is shown in FIG. 11 for the present embodiment, the write-inhibit flag identifying information is provided according to a given linear velocity. Moreover, the write-inhibit flag area that is provided in an optical disk that supports recording at a low linear velocity is in the same location as for an optical disk that supports recording at a high linear velocity, and the write-inhibit flag area corresponding to low linear velocities is provided in the management area of the conventional record/reproduce apparatus. Furthermore, in disks that only support recording at high linear velocities, the write-inhibit flag area is established such that recording is possible at a high linear velocity and is not possible at a low linear velocity.

As a result, depending on the recording linear velocity that corresponds to the record/reproduce apparatus, a suitable determination can be made as to whether recording is prohibited or not, which accomplishes the specific result that accidental low signal-quality recording to the medium is prevented.

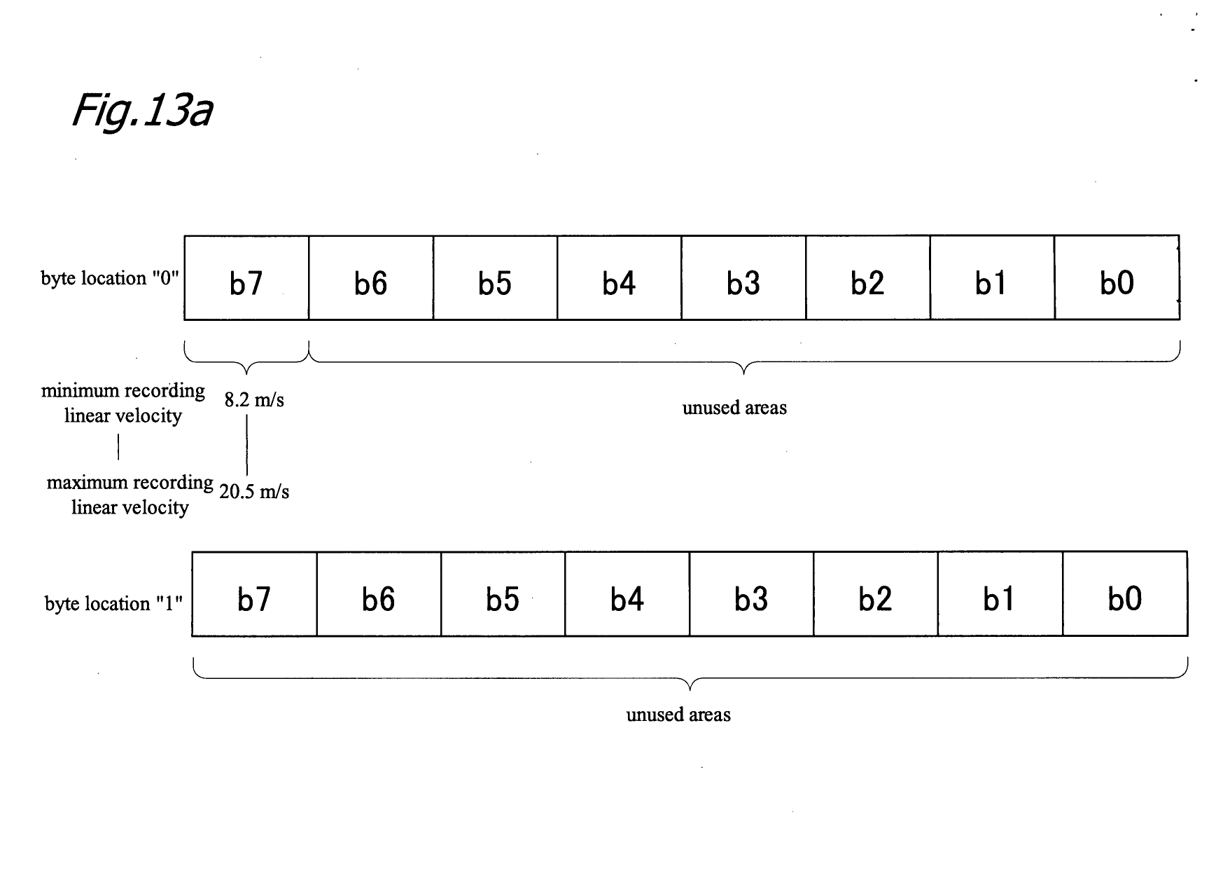

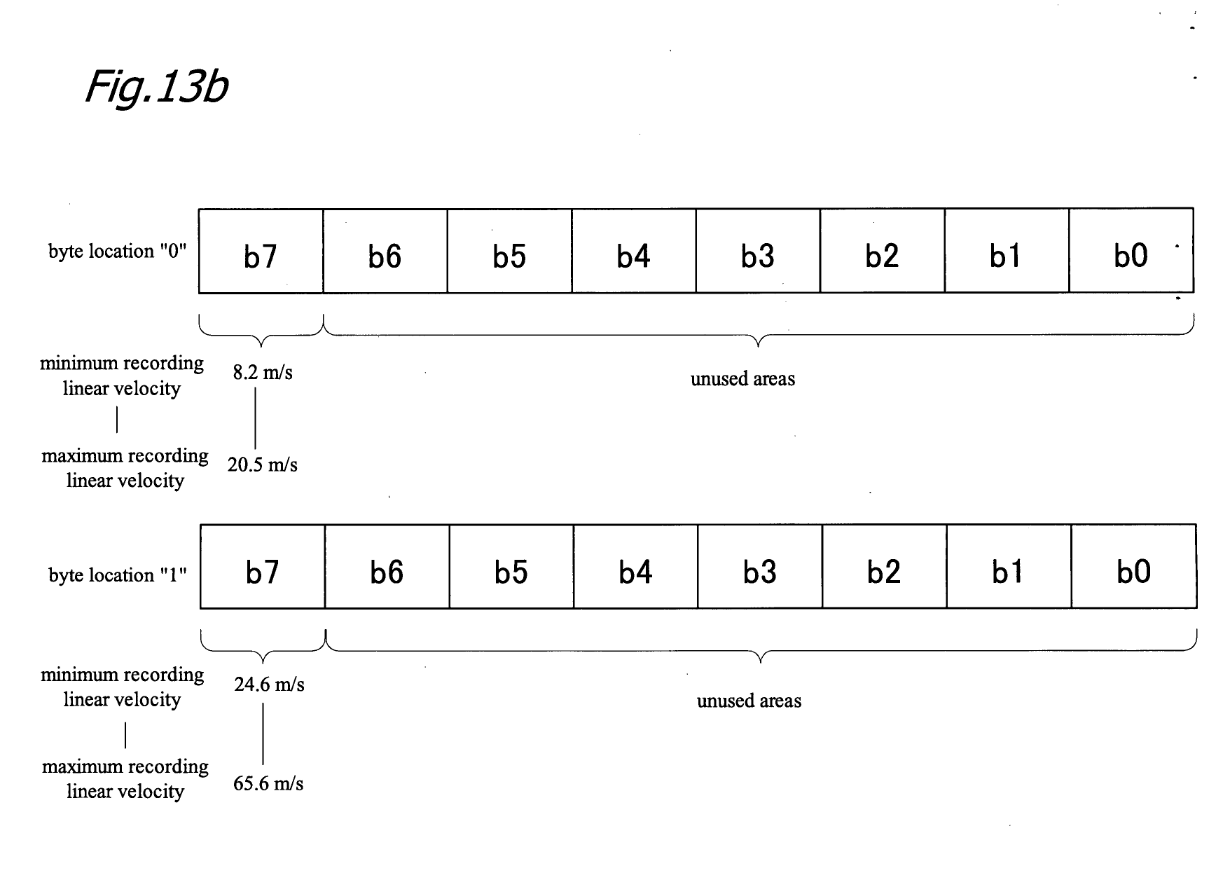

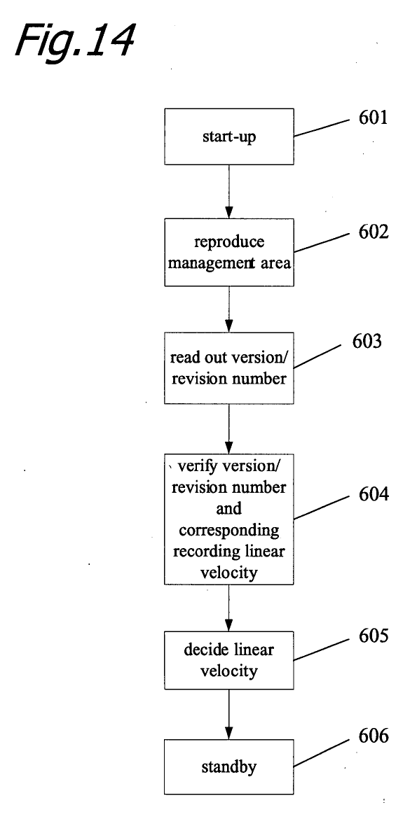

Furthermore, in the above embodiments, write-inhibit flag information according to the linear velocity is assigned to each bit within 1 byte, but the same result can also be obtained when each linear velocity is assigned to a separate byte, as shown in FIG. 13. For the configuration of the identifying information, FIG. 13a shows the case of an optical disk that corresponds to recording within the linear velocity range of from 8.2 m/s to 20.5 m/s, and FIG. 13b shows the case of a higher speed optical disk that corresponds to recording within the linear velocity range of from 24.6 m/s to 65.6 m/s. In both FIGS. 13a and 13b, the highest-order bit b7 of byte location “0” records the write-inhibit identifying information in the linear velocity range of from 8.2 m/s to 20.5 m/s. In FIG. 13b, the highest-order bit b7 of byte location “1” records the identifying information in the linear velocity range of from 24.6 m/s to 65.6 m/s. Additionally, in FIG. 13a, bits b6 through b0 of byte location “0” and all of byte location “1” are unused areas. In FIG. 13b, each of the bits b6 to b0 is unused areas.

Moreover, in the above embodiments, if the version/revision number for optical disk B is the same as that for optical disk A (in other words, if the version/revision number is known to record/reproduce apparatus A), the optical disks can be recognized reliably in conventional record/reproduce apparatus, and this is more preferable since it will be possible to prevent recording by mistake more reliably.

(Other Embodiments)

The identifying information in the above embodiments can be identifiers that are able to determine whether recording is possible or not possible at a recording linear velocity corresponding to a record/reproduce apparatus where a medium is possible to be loaded. The record/reproduce apparatus where a medium is possible to be loaded is that, for example, an apparatus that a version/revision number of the medium is not supported.

Identifying information that corresponds to fixed linear velocity ranges are provided in the above embodiments, but there is no problem with using single linear velocities.

There is no limitation of any kind that the above-described optical disks are of an overwritable-type or one write-type, and the above-described methods can be used for forming marks on a recording layer by the use of laser light on any suitable medium.

There is no limitation of any kind regarding the recording linear velocity, recording conditions, format, or assignment of areas or bits for the optical disks in any of the above-described embodiments. Among these, within the limitations of achieving the object of the present invention, one can establish any suitable configurations with respect to the medium or the record/reproduce apparatus. For example, a range of recordable linear velocities that is broader than that presented (in other words, the ratio of a minimum linear velocity to maximum linear velocity is over 2.6) in any of the embodiments is satisfactory. Additionally, in this case, the range of recordable linear velocities can be further separated in a plurality of ranges, then the write-inhibit identifying information can be recorded in bits.

Suitable applications of the optical information recording medium, optical information recording method, and optical information record/reproduce apparatus of the present invention include personal computers, servers, recorders as well as semiconductor circuits and the like.

What is claimed is:

1. An optical information recording medium that records or reproduces information through irradiation with laser light, comprising:
a recording area for recording the information; and
a management area for recording management information of the optical information recording medium,
wherein the management area includes a recordable write-inhibit flag area, and
at least two types of the identifying information that are independent one another and identify whether recording is prohibited or not respectively for at least two recording linear velocities are recorded in the write-inhibit flag area.

2. The optical information recording medium according to claim 1,
wherein the management area includes a disk identification area, and
the write-inhibit flag area is provided within the disk identification area.

3. The optical information recording medium according to claim 2, wherein the disk identification area includes:
a plurality of recording apparatus-specific information areas where the recording apparatus information that specifies the record/reproduce apparatus is recorded; and
a plurality of second write-inhibit flag areas where each of the second write-inhibit flag areas has a one-to-one correspondence with the recording apparatus-specific information areas, and
at least two types of the second identifying information that are independent one another and identify whether recording is prohibited or not respectively for at least two recording linear velocities are recorded in the second write-inhibit flag area.

4. The optical information recording medium according to claim 1,
wherein a plurality of the write-inhibit flag areas that have a one-to-one correspondence with at least the two recording linear velocities, and
among at least the two of the recording linear velocities, the identifying information is established so that recording is not possible in the write-inhibit flag area that manages operation of recording at one of the recording linear velocities, and
the identifying information is established so that recording is possible in the write-inhibit flag area that manages operation of recording at the other of the recording linear velocities.

5. The optical information recording medium according to claim 4,
wherein among at least the two of the recording linear velocities, the identifying information is established so that recording is not possible in the write-inhibit flag area that manages operation of recording at the lower of the recording linear velocities, and
the identifying information is established so that recording is possible in the write-inhibit flag area that manages operation of recording at the higher of the recording linear velocities.

6. The optical information recording medium according to claim 1,
wherein the write-inhibit flag area includes a version/revision identifier that identifies the version or revision of the optical information recording medium,
and a version or revision known on the record/reproduce apparatus is recorded in the version/revision identifier.

7. An optical information recording method for recording on the optical information recording medium according to claim 1,
performs the recording operation on the basis of the identifying information and/or the second identifying information.

8. The optical information recording method according to claim 7, comprising,
determining whether recording by the record/reproduce apparatus at the recording linear velocity is prohibited or not according to the identifying information of the write-inhibit flag area; and
if the recording is determined to be prohibited, determining whether recording by the record/reproduce apparatus at the recording linear velocity is prohibited or not based on the second identifying information that corresponds to the recording apparatus information.

9. The optical information recording method according to claim 8, further comprising,
determining whether the recording apparatus information that corresponds to the record/reproduce apparatus and the second identifying information that corresponds to the recording apparatus information are recorded or not between the two determining performances;
if the information are determined not to be recorded, performing a signal test write to be recorded by the record/reproduce apparatus at the recording linear velocity;
evaluating the reproduce quality for the test write of the signal; and
newly recording the recording apparatus information and the second identifying information to which the evaluation result is reflected.

10. An optical information record/reproduce apparatus for recording on the optical information recording medium according to claim 1,
comprising a control unit to control the recording operation based on the identifying information and/or the second identifying information.

11. The optical information record/reproduce apparatus according to claim 10, wherein the control unit includes:
a first determining unit that determines whether or not recording by the record/reproduce apparatus at the recording linear velocity is prohibited according to the identifying information of the write-inhibit flag area; and
a second determining unit that determines whether or not recording by the information record/reply apparatus at the recording linear velocity is prohibited according to the second identifying information that corresponds to the recording apparatus information if the first determining unit determines that recording is prohibited.

12. The optical information record/reproduce apparatus according to claim 11, wherein the control unit further includes:
a third determining unit between the first determining unit and the second determining unit, where the third determining unit determines whether or not the recording apparatus information that corresponds to the record/reproduce apparatus and the second identifying information that corresponds to the record/reproduce apparatus information is recorded;
a test write unit for performing a signal test write to be recorded by the record/reproduce apparatus if the third determining unit determines that there is no recording;
a fourth determining unit that evaluates the reproduce quality of the signal from the test write; and
an information recording unit that newly records the recording apparatus information and the second identifying information that the evaluation result of the fourth determining unit are reflected.

13. An optical information record/reproduce apparatus for recording on the optical information recording medium according to claim 1, comprising:
a spindle motor for the optical information recording medium to be rotated;
an optical head that irradiates the optical information recording medium with laser light;
a recording unit that controls the optical head so that recording information is recorded on the optical information recording medium;
a reproduce unit for reading out the identifying information and/or the second identifying information from the optical information recording medium;
a control unit to control the recording operation based on the identifying information and/or the second identifying information.

14. A semiconductor circuit for controlling the recording/reproducing of the optical information recording medium according to claim 1, comprising:
a control signal acquisition unit that acquires a control signal based on the identifying information and/or the second identifying information; and
a parameter adjustment unit that uses the acquired control signal to adjust the parameters that control the recording operation.
